(19) United States
(12) Patent Application Publication
(10) Pub. No.: US 2014/0291263 A1
(43) Pub. Date: Oct. 2, 2014

(54) ANTI-THEFT DISPLAY HANGER FOR SOCKET SETS

(71) Applicant: TING-AN CHEN, Taichung City (TW)

(72) Inventor: TING-AN CHEN, Taichung City (TW)

(21) Appl. No.: 13/851,894

(22) Filed: Mar. 27, 2013

(51) Int. Cl. B25H 3/04

(52) U.S. Cl. CPC B25H 3/04
USPC 211/70.6

(57) ABSTRACT

An anti-theft display hanger for socket sets contains a body and at least one support rod. The body includes at least one receiving space for receiving the at least one support rod, and each receiving space has two rotary shafts for connecting with each support rod. The each support rod includes two through holes for inserting the two rotary shafts and includes a plurality of posts for fitting a plurality of sockets, a bottom surface of the each support rod contacts with a bottom surface of each receiving space, and the each support rod also includes a chamfer for axially rotating the each support rod. The each support rod further includes two anti-theft retainers mounted on the two ends thereof so as to retain with the body, such that a rotation of the each support rod is limited by the two anti-theft retainers.

### FIELD OF THE INVENTION

The present invention relates to an anti-theft display hanger for socket sets which is capable of fixing socket sets on an anti-theft display hanger securely.

### BACKGROUND OF THE INVENTION

A conventional display hanger is used to fix and display a single socket, but the socket is removed from the display hanger easily without anti-theft function. To solve such a problem, an anti-theft display hanger for a single socket is developed. However, such an anti-theft display hanger is only for a single socket, so a plurality of sockets cannot be stored and displayed on the anti-theft display hanger simultaneously.

### SUMMARY OF THE INVENTION

The primary object of the present invention is to provide an anti-theft display hanger for socket sets which is capable of fixing socket sets on an anti-theft display hanger securely and has an anti-theft function.

To obtain the above objectives, an anti-theft display hanger for socket sets provided by the present invention contains: a body and at least one support rod.

The body includes at least one receiving space defined therein so as to receive the at least one support rod, and each receiving space has two rotary shafts disposed on two sides thereof so as to connect with each support rod, the each support rod includes two through holes defined on two ends thereof so as to insert the two rotary shafts and includes a plurality of posts extending upwardly from a top surface thereof so as to fit a plurality of sockets, a bottom surface of the each support rod contacts with a bottom surface of each receiving space, and the each support rod also includes a chamfer formed on an edge of the bottom surface thereof so as to axially rotate the each support rod.

The each support rod further includes two anti-theft retainers mounted on the two ends thereof so as to retain with the body, such that a rotation of the each support rod is limited by the two anti-theft retainers.

### BRIEF DESCRIPTION OF THE DRAWINGS

FIG. 1 is a perspective view showing the exploded components of an anti-theft display hanger for socket sets according to a preferred embodiment of the present invention.

FIG. 2 is a perspective view of a part A and a part B of FIG. 1.

FIG. 3 is a perspective view showing the assembly of the anti-theft display hanger for the socket sets according to the preferred embodiment of the present invention.

FIG. 4 is a plan view showing the assembly of the anti-theft display hanger for the socket sets according to the preferred embodiment of the present invention

FIG. 5 is a partial perspective view showing the operation of the anti-theft display hanger for the socket sets according to the preferred embodiment of the present invention.

FIG. 6 is a cross section view showing the operation of the anti-theft display hanger for the socket sets and taken along the lines 1-1 of FIG. 4.

FIG. 7 is another cross section view showing the operation of the anti-theft display hanger for the socket sets and taken along the lines 1-1 of FIG. 4.

### DETAILED DESCRIPTION OF THE PREFERRED EMBODIMENTS

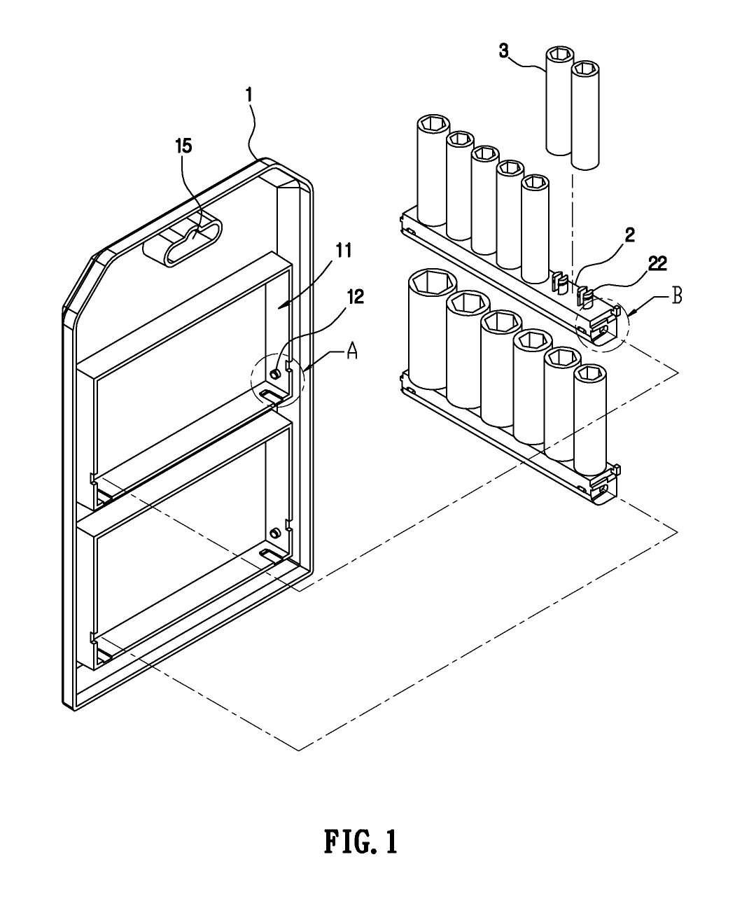

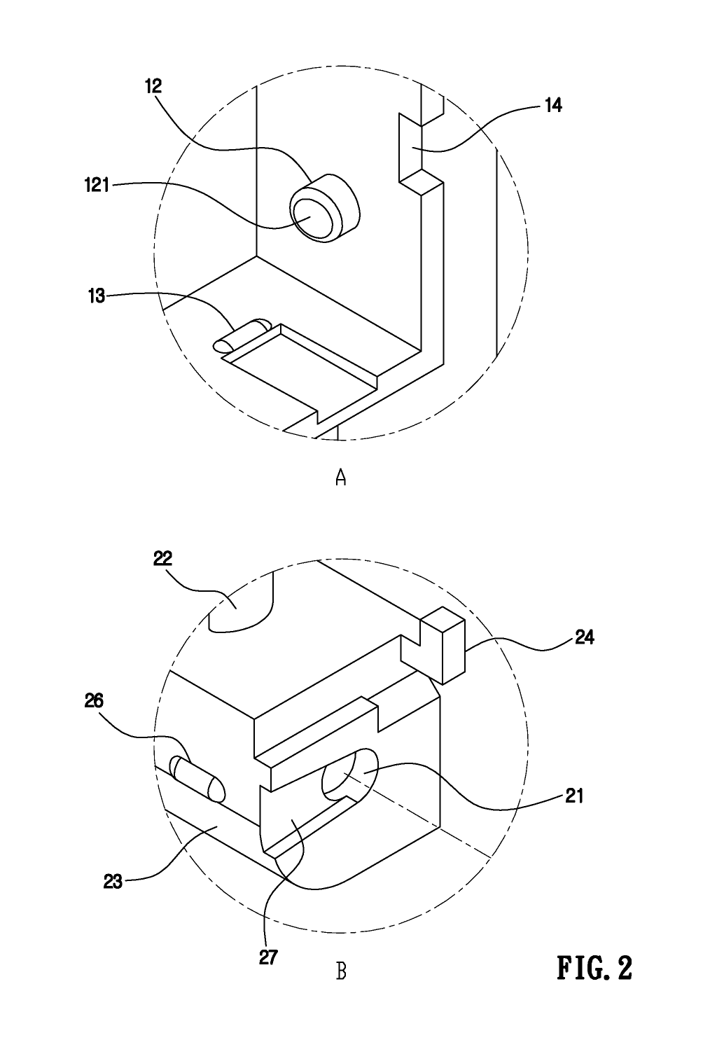

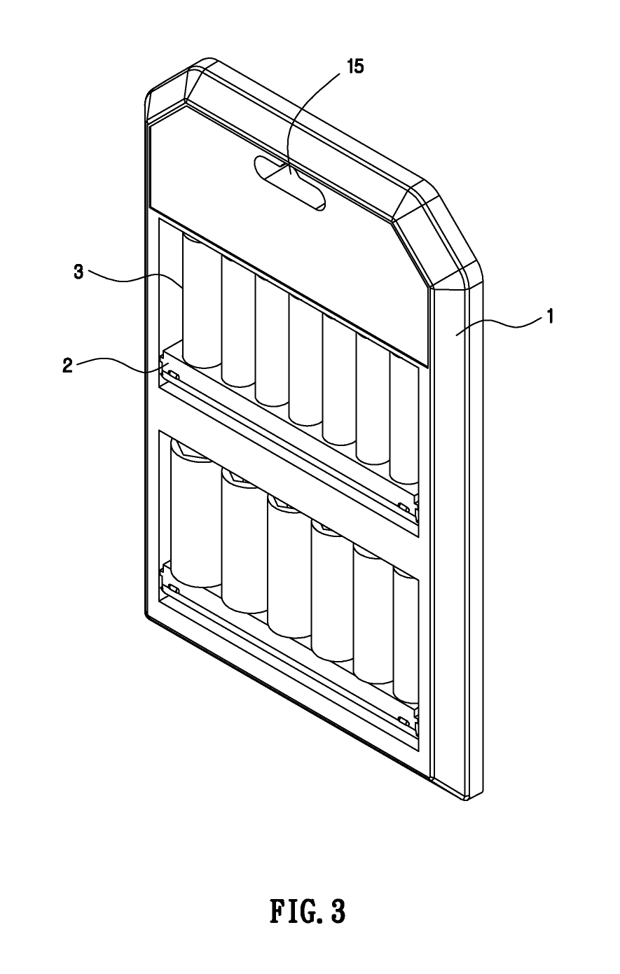

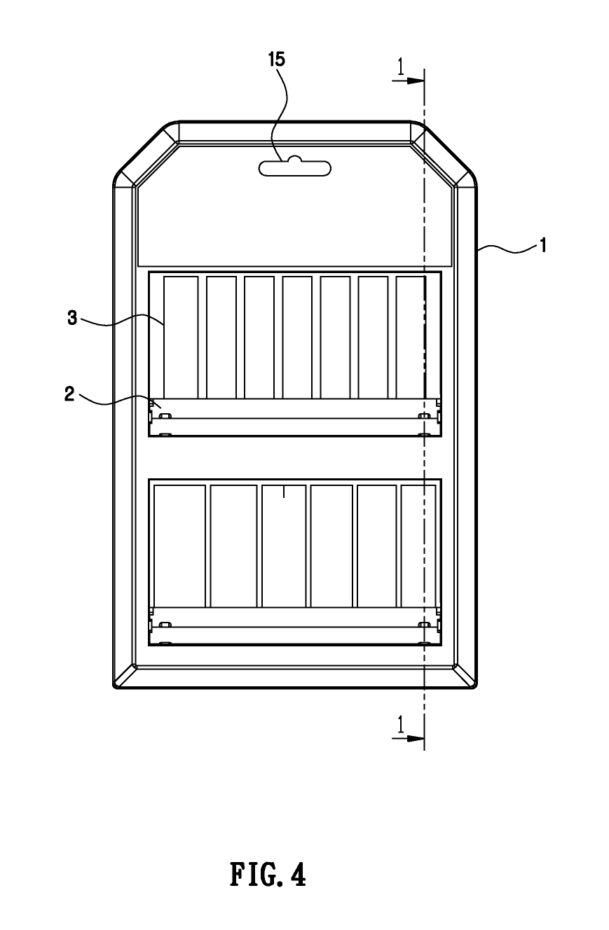

Referring to FIGS. 1-7, an anti-theft display hanger for socket sets according to a preferred embodiment of the present invention comprises: a body 1 and at least one support rod 2 (in this embodiment, two support rods 2 are fixed in the body 1).

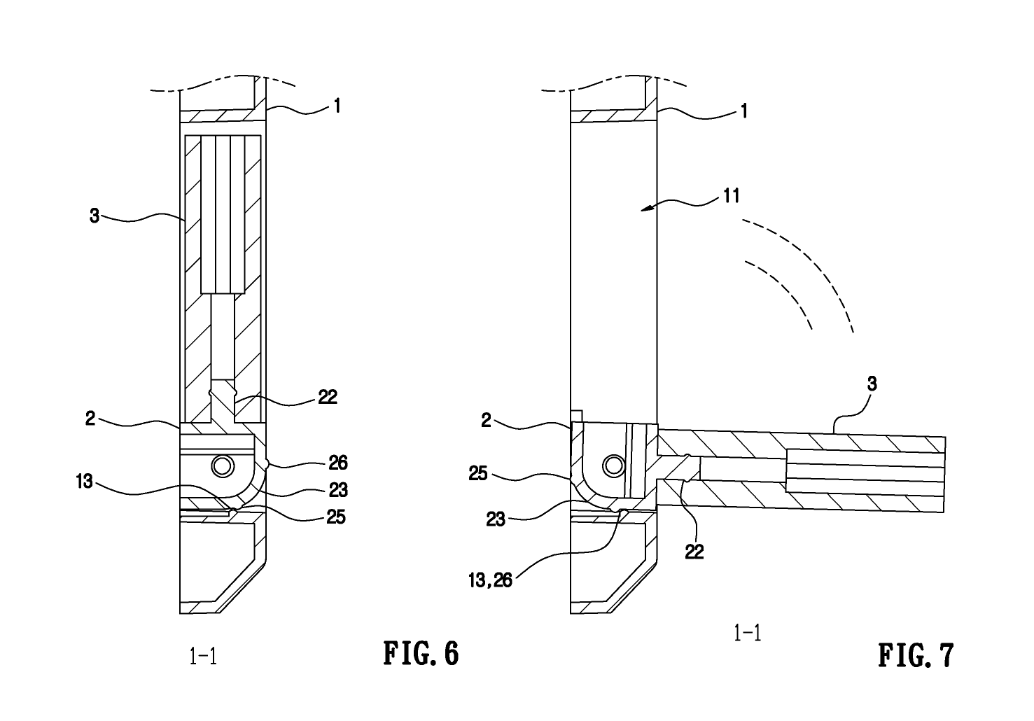

The body 1 includes at least one receiving space 11 defined therein so as to receive the at least one support rod 2, and each receiving space 11 has two rotary shafts 12 disposed on two sides thereof so as to connect with each support rod 2. The each support rod 2 includes two through holes 21 defined on two ends thereof so as to insert the two rotary shafts 12 and includes a plurality of posts 22 extending upwardly from a top surface thereof so as to fit a plurality of sockets 3. A bottom surface of the each support rod 2 contacts with a bottom surface of each receiving space 11, and the each support rod 2 also includes a chamfer 23 formed on an edge of the bottom surface thereof so as to axially rotate the each support rod 2 as shown in FIGS. 6 and 7.

The each support rod 2 further includes two anti-theft retainers 24 mounted on the two ends thereof so as to retain with the body 1, such that a rotation of the each support rod 2 is limited by the two anti-theft retainers 24.

Thereby, when each socket 3 is fitted onto each post 22, a distance between an upper end of the each socket 3 and a top surface of the each receiving space 11 is less than a length of the each post 22, so the distance between the upper end of the each socket 3 and the top surface of the each receiving space 11 does not interfere the rotation of the each socket 3 as illustrated in FIG. 6, and when the each support rod 2 is limited by the two anti-theft retainers 24, it does not rotate, such that the each socket 3 cannot be removed from the each post 22 because of an interference of the top surface of the each receiving space 11, thus obtaining anti-theft effect. After cutting the two retainers 24, the each support rod 2 is rotated outwardly so that the each socket 3 is removed from the each post 22 without being interfered by the top surface of the each receiving space 11 as shown in FIG. 7.

Moreover, the each support rod 2 includes a first locking protrusion 25 arranged on the bottom surface thereof so as to position the each support rod 2 at a first rotating angle and includes a second locking protrusion 26 formed on a front surface thereof so that the each support rod 2 is fixed at a second rotating angle (in this embodiment, the first locking protrusion 25 is arranged to store the each socket 3, and the second locking protrusion 26 is used to remove the each socket 3). Also, the each receiving space 11 of the body 1 includes a retaining projection 13 formed on the bottom surface thereof so as to retain with the first retaining projection 25 or the second retaining projection 26 such that the each support rod 2 is limited to rotated between the first rotating angle and the second rotating angle. Referring further to FIG. 6, when the first locking protrusion 25 retains with the retaining projection 13, the each socket 3 is stored. Also, as shown in FIG. 7, when the second locking protrusion 26 retains with the retaining projection 13, the each socket 3 is removed from the each post 22.

The each support rod 2 includes two tilted slots 27 defined on the two ends thereof and communicating with the two through holes 21, and each rotary shaft 12 has a guiding face 121 formed on an outer end thereof so as to match with each tilted slot 27, such that the each rotary shaft 12 is forced into each through hole 21 easily, thus connecting the each support rod 2 with the body 1 quickly.

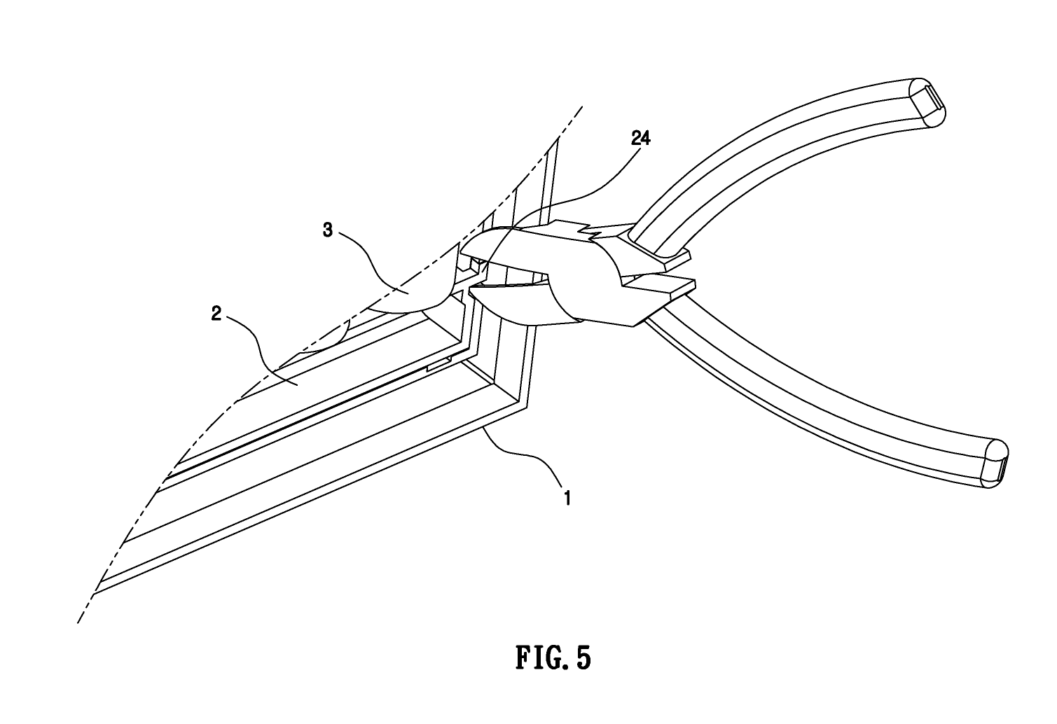

In addition, the body 1 includes two recesses 14 defined on the two sides of the each receiving space 11 thereof so as to retain with the two anti-theft retainers 24, and a diameter of each recess 14 is larger than that of each anti-theft retainer 24, such that a cutting tool cuts the each anti-theft retainer 24 at a preferred angle as illustrated in FIG. 5.

Likewise, the body 1 includes a hanging orifice 15 formed on an upper end thereof so as to hang an anti-theft display hanger.

Thereby, the body 1 and the at least one support rod 2 are arranged to hang the anti-theft display hanger so as to further display the plurality of sockets 3, and the two anti-theft retainers 24 of the each support rod 2 are configured to prevent the plurality of sockets 3 from being removed. Furthermore, the plurality of sockets 3 are removed easily by user after cutting the two anti-theft retainers 24 and are stored in the body 1.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An anti-theft display hanger for socket sets comprising:
a body and at least one support rod; wherein,
the body includes at least one receiving space defined therein so as to receive the at least one support rod, and each receiving space has two rotary shafts respectively disposed on two sides of the receiving space so as to rotatably connect with the respective support rod, each support rod including two through holes respectively defined on two ends thereof so as to respectively insert into the two rotary shafts, each support rod further including a plurality of posts extending upwardly from a top surface thereof configured to accept a plurality of sockets, a bottom surface of each support rod contacting a bottom surface of the respective receiving space, and each support rod also including a chamfer formed on an edge of the bottom surface of the support rod so as to permit axial rotation of the support rod with respect to the respective bottom surface; and
each support rod further includes at least two anti-theft retainers respectively mounted on the two ends of the support rod so as to engage with the body to prevent rotation of the support rod.

2. The anti-theft display hanger as claimed in claim 1, wherein each support rod further includes a first locking protrusion arranged on the bottom surface thereof so as to position the support rod at a first rotating angle, and includes a second locking protrusion formed on a front surface thereof so that the support rod is fixed at a second rotating angle, and each receiving space of the body includes a retaining projection formed on the bottom surface thereof so as to engage with the first retaining projection or the second retaining projection of the respective support rod such that each support rod is limited to rotate between the first rotating angle and the second rotating angle.

3. The anti-theft display hanger as claimed in claim 1, wherein each support rod further includes two angled slots respectively defined on the two ends thereof and respectively communicating with the two through holes, and each rotary shaft has a predetermined angle formed on an end surface thereof so as to match with an angle of the respective tilted slot, such that a guiding face of each rotary shaft is guided into the respective through hole.

4. The anti-theft display hanger as claimed in claim 1, wherein the body includes two recesses respectively defined on the two sides of each receiving space thereof so as to engage with the two anti-theft retainers, and a length of each recess is larger than a corresponding length of the respective anti-theft retainer.

5. The anti-theft display hanger as claimed in claim 1, wherein the body includes a hanging orifice formed on an upper end thereof so as to hang the anti-theft display hanger.
